(19) United States
(12) Patent Application Publication
(10) Pub. No.: US 2022/0364763 A1
(43) Pub. Date: Nov. 17, 2022

(54) VEHICLE FROST SUPPRESSION DEVICE

(71) Applicant: TOYOTA JIDOSHA KABUSHIKI KAISHA, Toyota-shi Aichi-ken (JP)

(72) Inventor: Takayuki Shimauchi, Toyota-shi Aichi-ken (JP)

(73) Assignee: TOYOTA JIDOSHA KABUSHIKI KAISHA, Toyota-shi Aichi-ken (JP)

(21) Appl. No.: 17/739,328

(22) Filed: May 9, 2022

(30) Foreign Application Priority Data
May 11, 2021 (JP) 2021-080471

(51) Int. Cl. F24F 13/10; B60H 1/32

(52) U.S. Cl. CPC F24F 13/10; B60H 1/321; B60H 2001/00961

(57) ABSTRACT

A frost suppression device for vehicles includes a grill shutter disposed in front of an outdoor heat exchanger for heating the cabin of the vehicle, a shutter control unit for controlling opening and shutting of the grill shutter, and a weather information obtaining unit for obtaining weather information containing change over time in predicted outside air temperature at the current position of the vehicle. The shutter control unit makes a prediction about frost formation to predict whether the outdoor heat exchanger may be frosted, based on the predicted outside air temperature, when the vehicle is first parked. The prediction about frost formation predicts that frost formation on the outdoor heat exchanger may begin at a time when the predicted outside air temperature becomes equal to or below a predetermined temperature. The shutter control unit shuts the grill shutter before a predicted frosting time.

### CROSS REFERENCE TO RELATED APPLICATION

This application claims priority to Japanese Patent Application No. 2021-080471 filed on May 11, 2021, which is incorporated herein by reference in its entirety including the specification, claims, drawings, and abstract.

### TECHNICAL FIELD

The present disclosure relates to a frost suppression device for vehicles, in particular, suppression of frost formation on an outdoor heat exchanger for use in heating the cabin of a vehicle while the vehicle is parked.

### BACKGROUND

JP2013-208938A discloses an air conditioning system for vehicles that employs a heat pump system. In this air conditioning system for vehicles, when a control device determines that a heating evaporator (an outdoor heat exchanger) is frosted, the outside air intake surface of the heating evaporator is covered with a cover member, operation of the outside air intake fan is stopped, and a heater mounted on the heating evaporator is activated, while a heating operation is continued.

In the case where an outdoor heat exchange for heating is frosted while the vehicle is parked, however, the outdoor heat exchanger remains frosted until the temperature of the outdoor heat exchanger or the ambient temperature increases to some extent even though the heating operation is continued with the outside air intake surface of an outdoor heat exchanger covered with a cover member and operation of the outside air intake fan stopped, after frosting on the outdoor heat exchanger begins. This impedes the heating capability of the air conditioning system.

### SUMMARY

The present disclosure aims to suppress frost formation on an outdoor heat exchanger for heating while the vehicle is parked.

According to one aspect of the present disclosure, there is provided a frost suppression device for a vehicle, including a grill shutter disposed in front of an outdoor heat exchanger for heating the cabin of the vehicle; a shutter control unit for controlling opening and shutting of the grill shutter; and a weather information obtaining unit for obtaining weather information containing change over time in predicted outside air temperature at the current position of the vehicle, wherein the shutter control unit makes a prediction about frost formation to predict whether frost may be formed on the outdoor heat exchanger, based on the predicted outside air temperature, when the vehicle is first parked, the prediction about frost formation predicts that frost formation on the outdoor heat exchanger may begin at a time when the predicted outside air temperature becomes equal to or below a predetermined temperature, and the shutter control unit shuts the grill shutter before a predicted frosting time when the frost formation on the outdoor heat exchanger is predicted to begin.

According to the above-described frost suppression device for vehicles, provided that being at a temperature equal to or below the predetermined temperature corresponds to high likelihood of frost formation, frost formation on an outdoor heat exchanger can be predicted before frost formation on the outdoor heat exchanger actually begins, when the vehicle is first parked, and the grill shutter can be shut before the predicted frosting time. As this can suppress frost formation on the grill shutter while the vehicle is parked, it is possible to suppress drop in the heating capability of the air conditioning system including the outdoor heat exchanger.

In the frost suppression device for a vehicle according to this disclosure, the weather information may contain change over time in at least one or more of predicted humidity, predicted snow accumulation, and a predicted speed of wind from the front side of the vehicle at the current position of the vehicle, and the prediction about frost formation may predict whether frost may be formed on the outdoor heat exchanger, based on the predicted outside air temperature and any one or more of the predicted humidity, the predicted snow accumulation, and the predicted speed of wind from the front side of the vehicle, when the vehicle is first parked.

As the above-described structure makes a frost prediction, based on the predicted outside air temperature and weather information other than the predicted outside air temperature, accuracy in frost prediction can be enhanced. For example, in the case where the predicted outside air temperature is only slightly higher than the predetermined temperature but not high enough to predict high likelihood of frost formation, based solely on the predicted outside air temperature, frost formation can be predicted with high accuracy provided that the predicted humidity, the predicted snow accumulation, or the predicted wind speed is equal to or higher than a respective predetermined value corresponding to high likelihood of frost formation. This enables further suppression of frost formation on the outdoor heat exchanger while the vehicle is parked.

The frost suppression device for a vehicle according to this disclosure may further include an indoor/outdoor determination unit for determining whether a vehicle equipped with the frost suppression device is located indoors or outdoors, and the shutter control unit does not make the prediction about frost formation and does not shut the grill shutter open when the indoor/outdoor determination unit determines that the vehicle is located indoors.

As the above-described structure does not shut the grill shutter when it is determined that the vehicle is located indoors, the grill shutter is less likely shut unnecessarily while the vehicle is parked. This can suppress heat accumulation in the power source compartment where the outdoor heat exchanger is disposed also when the vehicle has run with a high load before the vehicle is parked. This can suppress heat damage to the components disposed in the power source compartment.

In the frost suppression device for a vehicle according to this disclosure, the shutter control unit may determine the level of likelihood of frost formation when making the prediction about frost formation, based on the difference and the large/small relationship between the predicted outside air temperature, contained in the weather information, and the predetermined temperature, and may select the extent of opening of the grill shutter in accordance with the level determined.

According to the above-described structure, as the difference and the large/small relationship between the predicted outside air temperature and the predetermined temperature are significantly relevant to the frost likelihood level, use of the difference and the large/small relationship enables accurate determination of the frost likelihood level. Further, opening the grill shutter by an extent in accordance with the frost likelihood level, the extent being smaller than that of full opening can reduce the amount of air blowing toward the neighboring area of the front surface of the outdoor heat exchanger, compared with a case in which the grill shutter is fully opened. This can reduce the extent of drop in the heating capability by reducing the amount of frost, if any, formed on the outdoor heat exchanger. Further, as heat accumulation in the power source compartment, where the outdoor heat exchanger is disposed, can be suppressed, compared with a case in which the grill shutter is fully shut, it is possible to suppress heat damage to the components disposed in the power source compartment.

A frost suppression device for vehicles according to the present disclosure can suppress frost formation on the outdoor heat exchanger for heating while the vehicle is parked.

### BRIEF DESCRIPTION OF DRAWINGS

Embodiment(s) of the present disclosure will be described based on the following figures, wherein:

FIG. 1 is a schematic cross sectional view (a) of the front portion of a vehicle including a grill shutter constituting a frost suppression device according to a first embodiment of this disclosure, with an enlarged view (b) of a fin of the grill shutter illustrated;

FIG. 2 illustrates the structure of a frost suppression device according to the first embodiment;

FIG. 3 is a flowchart of an exemplary control method for frost suppression to be executed by the frost suppression device illustrated in FIG. 2;

FIG. 4 illustrates an exemplary relationship between change over time in a predicted outside air temperature and a predicted frosting time in the first embodiment;

FIG. 5 illustrates the structure of another exemplary frost suppression device in a second embodiment;

FIG. 6 illustrates an exemplary relationship between highly likely frosting areas and predicted outside air temperature and humidity in another example of the second embodiment;

FIG. 7 illustrates one exemplary relationship between predicted frosting time and change over time in predicted outside air temperature and humidity in another example of the second embodiment;

FIG. 8 is a flowchart of an exemplary control method for frost suppression to be executed by a frost suppression device in another example of a third embodiment;

FIG. 9 illustrates one exemplary relationship between a frosting likelihood level and a plurality of areas that are defined based on the relationship between the predicted outside air temperature and the predicted humidity in another example of the third embodiment; and

FIG. 10 is a flowchart of an exemplary control method for frost suppression to be executed by a frost suppression device in another example of a fourth embodiment.

### DESCRIPTION OF EMBODIMENTS

### First Embodiment

A frost suppression device for vehicles according to embodiments of the present disclosure will now be described referring to the following drawings. Specific shapes, dispositions, numbers of items, and so forth mentioned below in the description are only for the purpose of facilitating understanding of the present discourse, and can be arbitrarily modified according to the specifications of a vehicle including the frost suppression device.

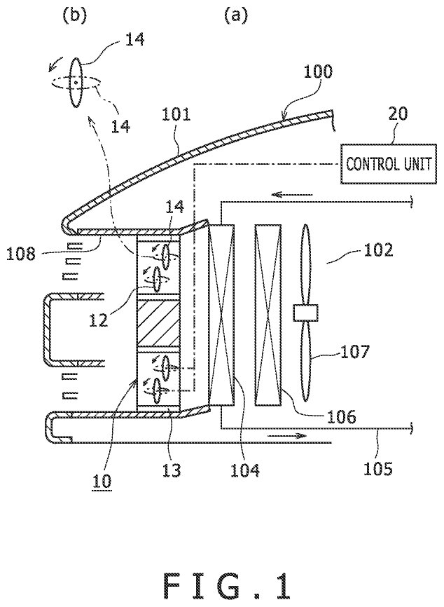

FIG. 1 is a schematic cross sectional view of the front portion of a vehicle 100 including a grill shutter 12 constituting a frost suppression device for vehicles 10 (hereinafter referred to as a frost suppression device 10) according to a first embodiment. The vehicle 100 includes the frost suppression device 10. The vehicle 100 also includes a power source compartment 102 on its front portion below a hood 101, where running power sources, not illustrated, such as a running motor, an engine, or the like, are disposed. In particular, an outdoor heat exchanger 104 is disposed in the front part of the power source compartment 102. The outdoor heat exchanger 104 constitutes a heat-pump heating system, or an air conditioning system for heating the cabin of the vehicle. Specifically, the heating system circulates refrigerant through a refrigerant circulation path 105. The circulating refrigerant flows into the outdoor heat exchanger 104, where the liquid refrigerant flowing therein evaporates into gas through heat exchange between the liquid refrigerant and outside air. After liquid content in the gaseous refrigerant is thoroughly removed in a gas-liquid separator, the remaining gaseous refrigerant is compressed with a compressor into a high temperature and high pressure gas. The refrigerant in the form of high temperature and high pressure gas undergoes heat exchange with water flowing in a water circulating path, not illustrated, whereby the temperature of the water is increased, before returning to the outdoor heat exchanger 104. The water at increased temperature, or hot water, due to heat exchange with the refrigerant circulating in the refrigerant circulation path 105 flows in the water circulation path to a heater core disposed inside an air conditioning duct, not illustrated. The hot water flowing in the heater core increases the temperature of the heater core. Meanwhile, air is taken into the air conditioning duct through an air inlet with a blower, and passes through the heater core before being sent toward a discharge port that is open toward the inside of the vehicle. The air at an increased temperature due to passage through the heater core is discharged from the discharge port. The outdoor heat exchanger 104 may function also as an outdoor condenser constituting a cooling system for cooling the inside of the cabin of the vehicle.

In front of the outdoor heat exchanger 104 in the vehicle 100, a running wind duct 108 is disposed for introducing outside air from the front side of the vehicle 100 rearward to the outdoor heat exchanger 104. The outside air then flows rearward through the outdoor heat exchanger 104 with operation of a cooling fan 107, disposed behind the outdoor heat exchanger 104 via a radiator 106 for cooling the engine. This can enhance heat exchange capability of the outdoor heat exchanger 104.

The grill shutter 12 is disposed inside the running wind duct 108. The grill shutter 12 has a fin 14, which is rotatably disposed inside a frame member 13. The fin 14 is rotated by a motor for a fin, not illustrated. A control unit 20 controls opening and shutting of the grill shutter 12. With the grill shutter 12 open, the fin 14 rotates to be in a position indicated with the broken line in FIG. 1, which allows smooth passage of air in the front-rear direction through the frame member 13. With the cooling fan 107 then driven, outside air can be introduced through the running wind duct 108 toward the outdoor heat exchanger 104. Meanwhile, with the grill shutter 12 shut; that is, with the fin 14 in the position indicated with the solid line in FIG. 1, a lesser amount of air is introduced through the running wind duct 108 toward the outdoor heat exchanger 104. When a vehicle is running at a high speed with the outdoor heat exchanger 104 not used, the grill shutter 12 can remain shut to decrease the air resistance of the vehicle. Meanwhile, when the outdoor heat exchanger 104 is used, the grill shutter 12 can remain open to thereby enhance the heat exchange capability with the outside air. The grill shutter 12 is kept open while the vehicle is parked normally under high outside air temperature to suppress heat accumulation in the power source compartment 102. This can suppress heat damage to the components in the power source compartment 102 while the vehicle is parked.

Meanwhile, while the vehicle is parked under low outside air temperature or with snow piled up therearound, the outdoor heat exchanger 104 may be frosted. This reduces the heating capability of the heating system at the time when the vehicle resumes driving. To address the above, the frost suppression device 10 predicts frost formation on the outdoor heat exchanger 104 while the vehicle is parked, based on a predicted outside air temperature at the current position of the vehicle 100, as to be described later in detail, and shuts the grill shutter 12 before a time when frost formation is predicted to begin (hereinafter referred to as a predicted frosting time). This can suppress frost formation on the outdoor heat exchanger 104 while the vehicle is parked, and thus can suppress drop in the heating capability of the heating system.

Here, frost is considered to be formed mainly by the causes below. One cause is snow attached to the outdoor heat exchanger 104. Snow attached to the outdoor heat exchanger 104 decreases the temperature of the surface of the outdoor heat exchanger 104, which leads to a large difference between the temperature of the surface and the outside air temperature. This can cause frosting. Another cause is a remarkable drop in temperature of the surface of the outdoor heat exchanger 104 due to extraordinarily low outside air temperature with a strong wind or the like, although not snowing. This also can cause frosting. In either case, frost is formed at outside air temperature lower than usual temperature. In view of the above, a time at which the outside air temperature becomes equal to or below a predetermined temperature is considered as a time at which frost formation on the outdoor heat exchanger 104 is expected to begin, or a predicted frosting time, in this example, and the grill shutter 12 is shut before the predicted frosting time, whereby frost formation on the outdoor heat exchanger 104 is suppressed.

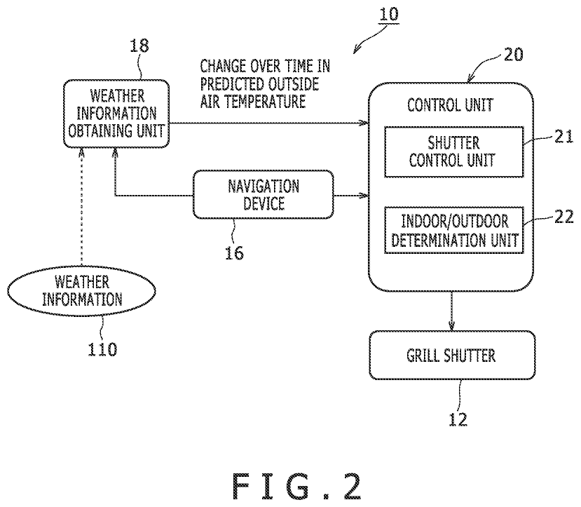

FIG. 2 illustrates the structure of the frost suppression device 10. The frost suppression device 10 includes the grill shutter 12, a navigation device 16, a weather information obtaining unit 18, and the control unit 20. The navigation device 16 obtains weather information 110 corresponding to the current position of the vehicle, using the weather information obtaining unit 18, to be described later, and determines whether the vehicle 100 is located indoors, using an indoor/outdoor determination unit 22, to be described later. Specifically, the navigation device 16 receives electric waves from an artificial satellite, using a Global Navigation Satellite System, or GNSS, such as Global Positioning System, or GPS, to obtain information indicating the current position of the vehicle.

The weather information obtaining unit 18 obtains change over time in the predicted outside air temperature at the current position of the vehicle as the weather information 110. Specifically, the weather information obtaining unit 18 obtains information on change in the predicted outside air temperature at the current position as time passes, or change over time, using a communication unit, from the Japan Meteorological Agency or weather forecasting companies, based on the current position information of the vehicle, obtained with the navigation device 16. The change over time in the predicted outside air temperature is obtained, for example, based on the relationship between a time point and a predicted outside air temperature at the time point for every unit period of time (for example, an hour), for example, beginning with the current time. The obtained change over time in the predicted outside air temperature is stored in a storage unit of the control unit 20.

The control unit 20 includes a microcomputer including an operation processing unit, such as a central processing unit, or CPU, and a storage unit, such as a memory. The control unit 20 further includes a shutter control unit 21 and the indoor/outdoor determination unit 22. The shutter control unit 21 makes a prediction about frost formation on the outdoor heat exchanger 104 while the vehicle is parked, based on the obtained weather information, when the vehicle is first parked. Specifically, the shutter control unit 21 makes a prediction about frost formation within a predetermined period of time, such as, within six hours or twelve hours, beginning with a time when the vehicle is first parked, based on the change over time in the predicted outside air temperature within the predetermined period of time. The predetermined period of time can be determined, based on a standard period of time during which many people park vehicles when parking for a relatively long period of time. The shutter control unit 21 compares a predetermined temperature stored in advance in the storage unit and a predicted outside air temperature, which varies as time passes, at a respective time point to predict whether frost may be formed. Specifically, the shutter control unit 21 predicts that frost formation begins at a time when the predicted outside air temperature becomes equal to or below the predetermined temperature, to thereby predict a time at which frost formation is expected to begin. The predetermined temperature may be −3° C. or the like; that is, a temperature considered corresponding to high likelihood of frost formation when the outside air temperature is at the temperature or therebelow.

With a prediction of frost formation on the outdoor heat exchanger 104 with the vehicle parked, the shutter control unit 21 shuts the grill shutter 12 before the predicted frosting time. More specifically, in the case where the shutter control unit 21 makes a prediction when the vehicle is first parked that frost may be formed, the shutter control unit 21 controls the grill shutter 12 to shut at the time when the shutter control unit 21 makes the prediction; that is, when the vehicle is first parked. Hence, as the grill shutter 12 is shut before frost formation begins, it is possible to suppress frost formation on the outdoor heat exchanger 104 while the vehicle is parked, and thus to suppress drop in the heating performance.

More specifically, the shutter control unit 21 makes a prediction about frost formation at the time when the vehicle is first parked, as determined by turning off the key switch of the vehicle or an activation switch, such as an activation button or the like, and in the case that frost formation on the outdoor heat exchanger 104 is expected, the fin motor of the grill shutter 12 is controlled to shut the grill shutter 12. Thereafter, power supply to the control unit 20 is discontinued. This can suppress reduction in charge amount of the battery, as power supply from the battery to the control unit 20 is no longer necessary.

The navigation device 16 stores map information, and obtains the current position, on a map, of the vehicle. Map information contains position information on indoor parking lots of facilities having indoor parking lots, such as shopping centers.

The indoor/outdoor determination unit 22 of the control unit 20 determines whether the vehicle is located indoors or outdoors, based on the information from the navigation device 16. Upon determination by the indoor/outdoor determination unit 22 that the vehicle is located indoors, the shutter control unit 21 neither makes the above-mentioned prediction about frost formation nor shuts the grill shutter 12. This can reduce the frequency of unnecessary shutting of the grill shutter 12, for example, when frost formation is not expected since the outside air temperature of the vehicle is higher than the predicted outside air temperature and air at lower temperature is not blown to the outdoor heat exchanger 104 as the vehicle is located indoors, even though frost formation is predicted according to a prediction based solely on the predicted outside air temperature contained in the weather information. As this can avoid heat accumulation in the power source compartment 102 where the outdoor heat exchanger 104 is disposed also when the vehicle has run with a large load before the vehicle parks, damage to the components inside the power source room 102 can be suppressed.

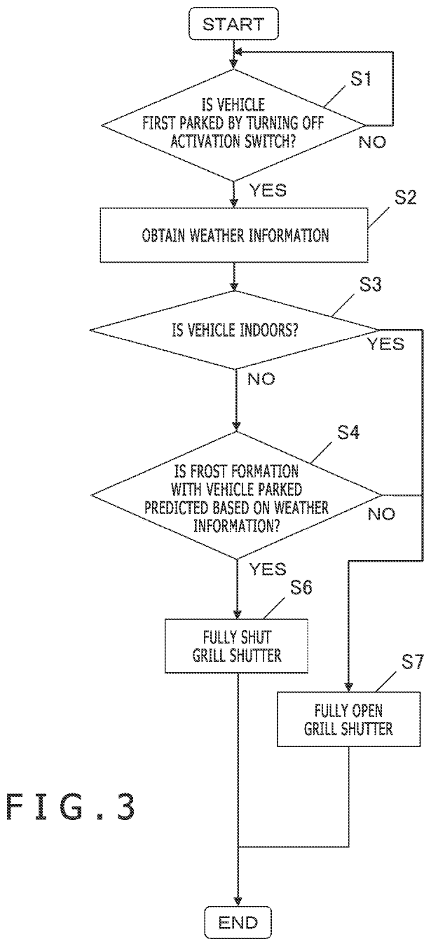

An exemplary control method for suppressing frost formation to be executed by the control unit 20 of the frost suppression device 10 will now be described by reference to the flowchart in FIG. 3. As the grill shutter 12 is generally fully opened before the vehicle is parked normally, the following description is based on this premise. Initially, in step S1 in FIG. 3, whether the activation switch of the vehicle has been turned off and the vehicle is first parked is determined. With determination of NO in step S1, the procedure returns to before step S1. Meanwhile, with determination of YES in step S1, in step S2 the weather information 110 is obtained with the weather information obtaining unit 18.

Thereafter, in step S3, the indoor/outdoor determination unit 22 determines whether the vehicle is located indoors. With determination of YES, or when it is determined that the vehicle is located indoors, the procedure advances to step S7, where the shutter control unit 21 does not shut the grill shutter 12, but keeps the grill shutter 12 fully opened, and ends the procedure without making a prediction about frost formation.

Meanwhile, with determination of NO in step S3, or when it is determined that the vehicle is not located indoors, whether frost formation while the vehicle is parked is predicted based on weather information is determined in step S4.

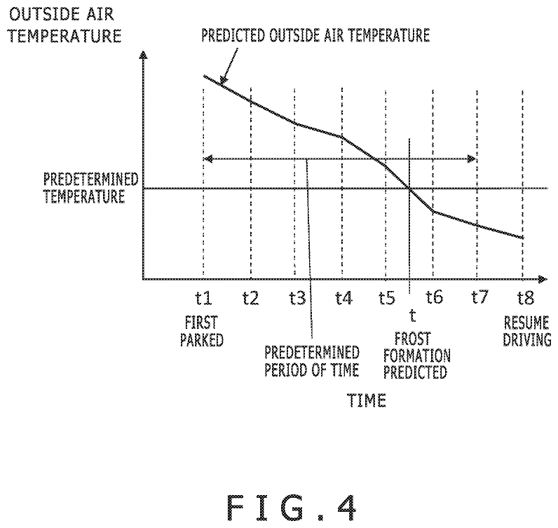

FIG. 4 illustrates one exemplary relationship between change over time in the predicted outside air temperature and a predicted frosting time in this embodiment. In the example in FIG. 4, provided that the time at which the vehicle is first parked is defined as time t1, an expected outside air temperature is thereafter obtained for every hour (t2, t3, . . . t7) until elapse of a predetermined period at time t7. In FIG. 4, each interval between the adjacent vertical broken lines corresponds to one hour. In FIG. 4, the predicted outside air temperature gradually decreases from time t1 when the vehicle is first parked to drop below a predetermined temperature at time t within the predetermined period of time. Hence, it is predicted that frost formation may begin while the vehicle is parked, and that the predicted frosting time is at time t. In the example in FIG. 4, the vehicle resumes driving at time t8 after the predicted frosting time t. Needless to say, the vehicle may resume driving before the predicted frosting time t instead. In this case, in actuality, the outdoor heat exchanger 104 is not frosted while the vehicle is parked, even if the grill shutter 12 is not shut. The structure in this example, however, can suppress frost formation on the outdoor heat exchanger 104 even if the vehicle resumes driving after the predicted frosting time t. During the period from when the vehicle resumes driving to when the vehicle stops driving, whether the outdoor heat exchanger 104 is currently frosted may be determined with a known traditional method, based on the temperature of the surface of the outdoor heat exchanger 104 and the detected outside air temperature or the like. The control unit 20 may shut the grill shutter 12 when it is determined that the outdoor heat exchanger 104 is currently frosted.

Returning to FIG. 3, with determination of YES in step S4, or when it is determined that frost formation while the vehicle is first parked is predicted, as is in the example illustrated in FIG. 4, the procedure advances to step S6, where the shutter control unit 21 shuts the grill shutter 12 (fully shut), and ends the procedure. In the above, the shutter control unit 21 shuts the grill shutter 12 at time t1 in FIG. 4.

Meanwhile, with determination of NO in step S4, or when it is determined that frost formation while the vehicle is parked is not predicted, the procedure advances to step S7, where the shutter control unit 21 keeps the grill shutter 12 open (fully opened) at time t1 in FIG. 4, and ends the procedure.

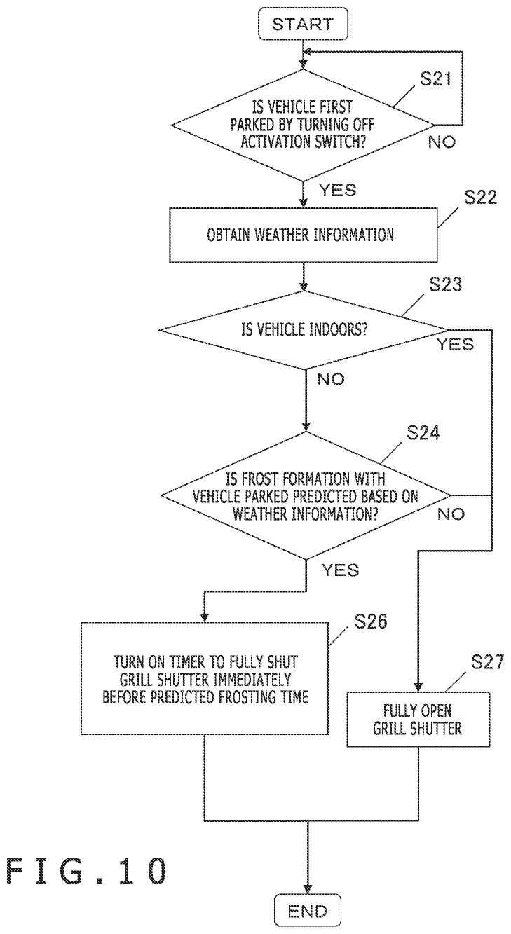

In the case where being at a temperature equal to or below the predetermined temperature indicates high likelihood of frost formation, the above-described frost suppression device 10 can predict frost formation before frost formation on the outdoor heat exchanger 104 actually begins, when the vehicle is first parked, and shut the grill shutter 12 at time t1 (FIG. 4) before the predicted frosting time t (FIG. 4). This can suppress frost formation on the outdoor heat exchanger 104 while the vehicle is parked, and thus can suppress drop in the heating capability of the heating system including the outdoor heat exchanger 104. As the grill shutter 12 is shut before the predicted frosting time, drop in the heating capability of the outdoor heat exchanger 104 due to frost can be suppressed also in the case where the heating system is turned on through remote control before the vehicle resumes driving. According to this disclosure, the essence is that the grill shutter is shut before a predicted frosting time upon prediction of frost formation on the outdoor heat exchanger 104 with the vehicle parked. Thus, a timing at which to shut the grill shutter is not limited to a time when frost formation with the vehicle parking is predicted, as is in the above-described example, but the grill shutter may be shut immediately before the predicted frosting time, as is the case with a structure according to another example to be described later by reference to FIG. 10.

### Second Embodiment

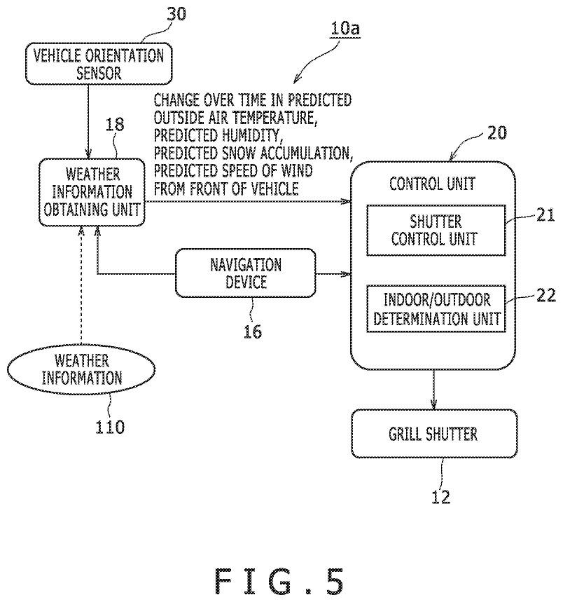

FIG. 5 illustrates the structure of a frost suppression device 10a according to a second embodiment. In this structure of this example, the weather information obtaining unit 18 obtains weather information containing change over time in predicted humidity, predicted snow accumulation, and predicted speed of wind blowing from the front side of the vehicle (hereinafter referred to as a predicted speed of head wind) at the current position of the vehicle, in addition to change over time in the predicted outside air temperature at the current position of the vehicle. Further, the frost suppression device 10a has a vehicle orientation sensor 30, composed of a gyro sensor or the like mounted on the vehicle, for determining the current orientation of the vehicle. The weather information obtaining unit 18 obtains change over time in the predicted speed of head wind at the current position of the vehicle, based on the information determined by the vehicle orientation sensor 30 and the change over time in the predicted speed and direction of wind at the current position, obtained from the Japan Meteorological Agency or the like, using an equation and/or a map. The equation or the map may be obtained based on the relationship between the orientation of the vehicle and the speed and direction of wind, the relationship being obtained in advance in experiments. The obtained predicted outside air temperature, predicted humidity, predicted snow accumulation, and predicted speed of head wind are stored in the storage unit of the control unit 20.

The shutter control unit 21 makes a prediction, when the vehicle is first parked, as to whether the outdoor heat exchanger 104 may be frosted, based on a plurality of weather information items (hereinafter referred to as weather factors), such as the predicted outside air temperature, the predicted humidity, the predicted snow accumulation, and the predicted speed of head wind. Specifically, the shutter control unit 21 utilizes a plurality of predetermined factor relation values, which are stored in advance in the storage unit so as to correspond to the plurality of respective weather factors contained in the weather information. That is, the shutter control unit 21 predicts whether the outdoor heat exchanger 104 may be frosted, through comparison between the predicted outside air temperature at each time point as the predicted outside air temperature changes as time passes, any weather factor other than the predicted outside air temperature at the time point as the weather factor changes as time passes, and a corresponding predetermined factor relation value.

For example, the shutter control unit 21 predicts that frost formation on the outdoor heat exchanger 104 may begin at a time when the predicted outside air temperature becomes equal to or below a first predetermined temperature T1 or a time when the predicted outside air temperature becomes equal to or below a second predetermined temperature T2 (for example, 0° C.) and higher than the first predetermined temperature T1 and at least one (predicted humidity or the like) of the weather factors other than the predicted outside air temperature takes a corresponding predetermined factor relation value (a predetermined humidity or the like) or a higher value. The first predetermined temperature T1 corresponds to the predetermined temperature that is set in the structure illustrated in FIGS. 1 to 4, while the second predetermined temperature T2 corresponds to a temperature higher than the first predetermined temperature T1.

Initially, a case in which frost prediction is made based on a combination between the predicted outside air temperature and the predicted humidity will be described. In this case, a predetermined humidity K (for example, 40%) is stored in advance in the storage unit of the control unit 20 as a predetermined factor relation value of the predicted humidity. The shutter control unit 21 predicts as a frosting time a time at which the predicted outside air temperature becomes equal to or below the first predetermined temperature T1 or a time at which the predicted outside air temperature becomes equal to or below the second predetermined temperature T2 and higher than the first predetermined temperature T1 and the predicted humidity becomes equal to or higher than the predetermined humidity K.

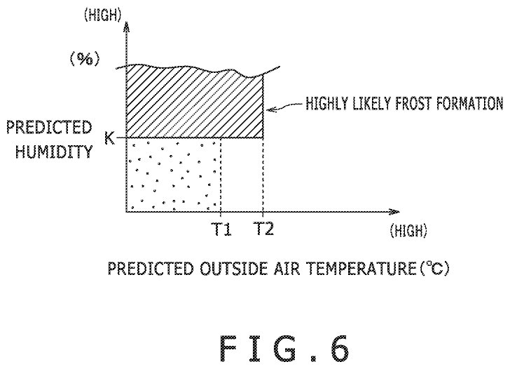

FIG. 6 illustrates the relationship between the predicted outside air temperature, the predicted humidity, and an area where frost formation is highly likely expected (hereinafter referred to as a highly likely frosting area). Specifically, the diagonally hatched area in FIG. 6 indicates a highly likely frosting area, which is determined based on the relationship between the predicted outside air temperature and the predicted humidity. The highly likely frosting area is an area where the predicted outside air temperature is equal to or below the second predetermined temperature T2 and the predicted humidity is equal to or higher than the predetermined humidity K. Under this condition that makes a highly likely frosting area, frost formation on the outdoor heat exchanger 104 can be predicted. In this example, the dotted area in FIG. 6 also is considered as an area where frost formation on the outdoor heat exchanger 104 is likely caused, based on an assumption that the likelihood of frost formation (hereinafter referred to as frosting likelihood) in the dotted area in FIG. 6; that is, an area under a condition that the predicted outside air temperature is equal to or below the first predetermined temperature T1 and the predicted humidity is below the predetermined humidity K, is higher than that in other areas, although lower than that in the highly likely frosting area.

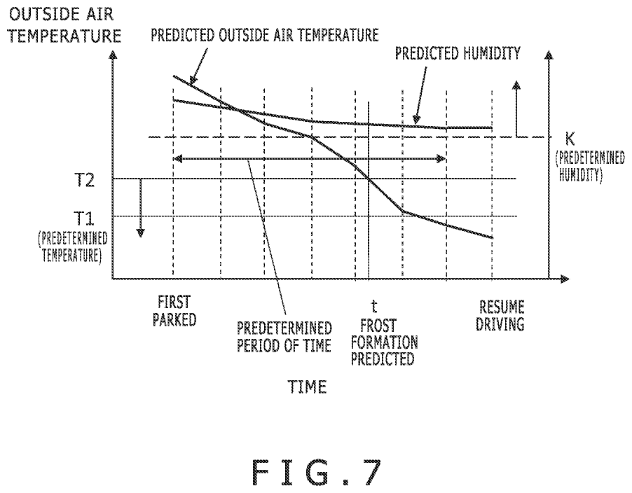

FIG. 7 illustrates an exemplary relationship between a predicted frosting time and change over time in the predicted outside air temperature and the predicted humidity. In this example in FIG. 7, the predicted outside air temperature becomes equal to or below the second predetermined temperature T2 and the predicted humidity becomes equal to or higher than the predetermined humidity K at time t within a predetermined period of time after the time when the vehicle is first parked and before the vehicle resumes driving. Hence, frost formation while the vehicle is parking is predicted, and the predicted frosting time is at time t.

In the case where frost prediction is made based on a combination between the predicted outside air temperature and the predicted snow accumulation, a predetermined snow accumulation (for example, between 40 cm and 60 cm) is stored in advance in the storage unit of the control unit 20 as a predetermined factor relation value of the predicted snow accumulation. The shutter control unit 21 predicts as a frosting time a time when the predicted outside air temperature becomes equal to or below the first predetermined temperature T1 or a time when the predicted outside air temperature becomes equal to or below the second predicted outside air temperature T2 and higher than the first predetermined temperature T1 and the predicted snow accumulation becomes equal to or larger than the predetermined snow accumulation.

In the case where frost prediction is made based on a combination between the predicted outside air temperature and the predicted speed of head wind, a predetermined wind speed (for example, 5 m/s) is stored in advance in the storage unit of the control unit 20 as a predetermined factor relation value of the predicted speed of head wind. The shutter control unit 21 predicts as a fronting time a time when the predicted outside air temperature becomes equal to or below the first predetermined temperature T1 or a time when the predicted outside air temperature becomes equal to or below the second predetermined temperature T2 and higher than the first predetermined temperature T1 and the predicted speed of head wind becomes equal to or faster than the predetermined wind speed.

This structure in this example, in which frost prediction is made based on the predicted outside air temperature and weather information other than the predicted outside air temperature, can enhance the accuracy in frost prediction. For example, also in the case where the predicted outside air temperature is only slightly higher than the first predetermined temperature T1 but not high enough to predict high likelihood of frost formation, based solely on the predicted outside air temperature, this structure can predict frost formation with high accuracy, provided that the predicted humidity, the predicted snow accumulation, or the predicted wind speed is equal to or higher than the predetermined humidity K, the predetermined snow accumulation, or the predetermined wind speed, respectively; that is, a predetermined value corresponding to high likelihood of frost formation. This enables further suppression of frost formation on the grill shutter 12 while the vehicle is parked. Note that structures and operations other than those described above in this example are the same as those of the structure illustrated in FIG. 1 to FIG. 4.

Alternatively, the weather information obtaining unit 18 in this structure according to this example may obtain change over time in the predicted outside air temperature and change over time in any one or two of the predicted humidity, the predicted snow accumulation, and the predicted speed of head wind, so that the shutter control unit 21 may make a prediction about frost formation, based on the predicted outside air temperature and one or two of the predicted humidity, the predicted snow accumulation, and the predicted speed of head wind.

### Third Embodiment

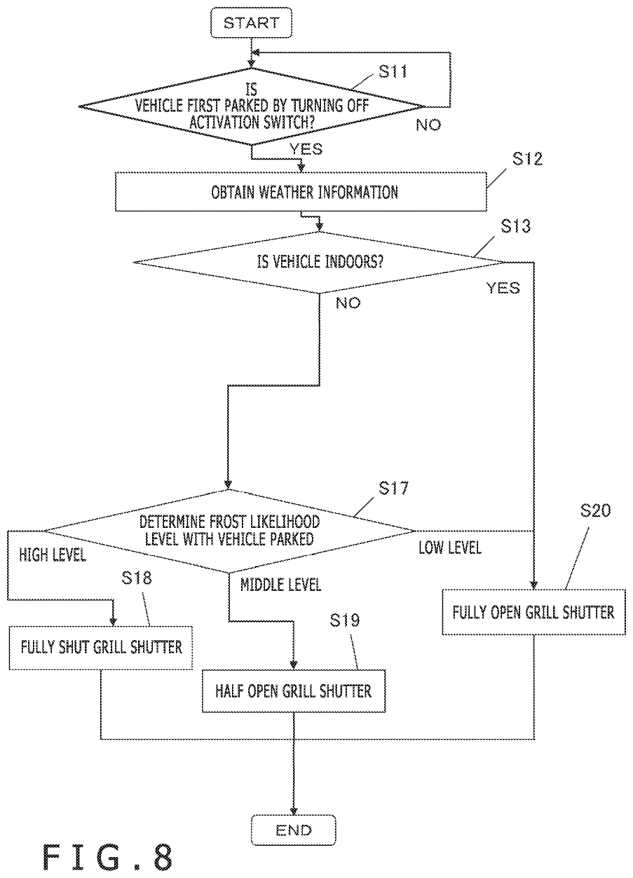

FIG. 8 is a flowchart of one exemplary control method for suppressing frost formation to be executed by a frost suppression device in a third embodiment. The structure in this example can switch between opening and shutting of the grill shutter 12 and can also set the grill shutter 12 to half opening, or an intermediate opening in which the grill shutter 12 is opened by an extent smaller than that of full opening. That is, in this example, the extent of opening of the grill shutter 12 is selected based on the frost likelihood level. A half opening may correspond to an opening by an extent that allows an amount of air equal to about 50% of the amount of air passing through the fully opened grill shutter 12 to pass through the grill shutter 12 in the front-rear direction. Alternatively, the extent of opening of a half opening may be arbitrarily set to any extent that allows an amount of air between 0 and 100% of the mount of air passing through the fully opened grill shutter 12 to pass through the grill shutter 12.

Specifically, the shutter control unit 21 of the frost suppression device 10 determines the frost likelihood level, based on the difference and a large/small relationship; that is, which of the two is higher or lower, for example, than the other, between the predetermined outside air temperature, contained in the weather information, and a predetermined temperature, to thereby select an extent of opening of the grill shutter 12 in accordance with the level, when making a frost prediction. This enables accurate determination of the frost likelihood level, as to be described later in detail. Setting the grill shutter 12 to half opening enables coordination between suppression of drop in the heating capability relative to a case of full opening and suppression of heat damage to the components in the power source room 102 relative to a case of full opening.

Referring to FIG. 8, a control method for suppressing frost formation will be described in more detail. Note that the processes in steps S11 to S13, S18, and S20 in FIG. 8 are the same as those in steps S1 to S3, S6, and S7 in FIG. 3, respectively. With determination of NO in step S13 in FIG. 8, the procedure advances to step S17, where the shutter control unit 21 determines a frost likelihood level.

Specifically, in step S17, in the case where the predicted outside air temperature is higher than a predetermined temperature and the difference between the predicted outside air temperature and the predetermined temperature is equal to or larger than a predetermined temperature difference D, the frost likelihood level is determined low, and the grill shutter 12 is fully opened (step S20).

Alternatively, in the case where the predicted outside air temperature is equal to or below the predetermined temperature in step S17, the frost likelihood level is determined high, and the grill shutter 12 is fully shut (step S18). Alternatively, in the case where the predicted outside air temperature is higher than the predetermined temperature and the difference between the predicted outside air temperature and the predetermined temperature is smaller than the predetermined temperature difference D in step S17, the frost likelihood level is determined middle, and the grill shutter 12 is half opened (step S19). After the process in any of steps S18 to S20, the procedure for controlling suppression of frost suppression ends.

In the above-described structure, as the difference and the large/small relationship between the predicted outside air temperature and the predetermined temperature are remarkably relevant to the frost likelihood level, use of the difference and the large/small relationship enables accurate determination of the frost likelihood level. Further, setting the grill shutter 12 to half opening in accordance with the frosting likelihood level; that is, opening by an extent smaller than that of full opening, can reduce the amount of wind blowing toward the neighboring area of the front surface of the outdoor heat exchanger 104, as compared with a case in which the outdoor heat exchanger 104 is fully opened. This can reduce the extent of drop in the heating capability when the outdoor heat exchanger 104 should be frosted, by reducing the amount of frost formed on the outdoor heat exchanger 104. Further, in this case, as heat accumulation in the power source compartment 102, where the outdoor heat exchanger 104 is disposed, can be suppressed, as compared with a case in which the grill shutter 12 is fully shut, heat damage to the components inside the power source compartment 102 can be suppressed. In this example, the structures and operations other than those mentioned above are the same as those of the structure in FIG. 1 to FIG. 4.

Note that in the case that a prediction about frost formation is made based on the predicted outside air temperature and weather factors other than the predicted outside air temperature, such as predicted humidity, as is in the above-described structure illustrated in FIG. 5 to FIG. 7, the frost likelihood level may be determined, based on the difference and the large/small relationship between the predicted outside air temperature and the predetermined value, and the difference and the large/small relationship between any weather factor (for example, predicted humidity) other than the predicted outside air temperature and a corresponding predetermined factor relation value.

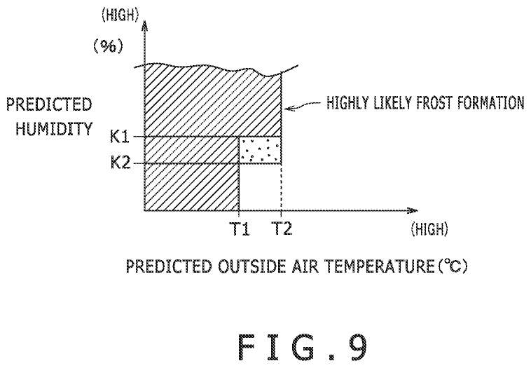

FIG. 9 illustrates an exemplary relationship between the frost likelihood level and a plurality of areas that are defined based on the relationship between the predicted outside air temperature and the predicted humidity in another example of the embodiment. For example, FIG. 9 illustrates a plurality of areas corresponding to a plurality of respective frost likelihood levels, which are referred to when a prediction about frost formation on the outdoor heat exchanger 104 is made based on the predicted outside air temperature and the predicted humidity. Specifically, the white area, the dotted area, and the diagonally hatched area in FIG. 9 correspond to the low, middle, and high frost likelihood levels, respectively. A structure for determining a frost likelihood level, based on the relationship illustrated in FIG. 9, determines that the frost likelihood level is high in the diagonally hatched area in FIG. 9; that is, an area in which the predicted outside air temperature is equal to or below the first predetermined temperature T1 and an area in which the predicted outside air temperature is higher than the first predetermined temperature T1 and equal to or below the second predetermined temperature T2 and the predicted humidity is equal to or higher than the first predetermined humidity K1, and fully shuts the grill shutter 12 in this area. Further, the structure determines that the frost likelihood level is low in the white area in FIG. 9; that is, an area in which the predicted outside air temperature is higher than the second predetermined temperature T2 and an area in which the predicted outside air temperature is higher than the first predetermined temperature T1 and equal to or below the second predetermined temperature T2 and the predicted humidity is below a second predetermined humidity K2, and fully opens the grill shutter 12 in this area. Further, the structure determines that the frost likelihood level is middle in the dotted area in FIG. 9; that is, an area in which the predicted outside air temperature is higher than the first predetermined temperature T1 and equal to or below the second predetermined temperature T2 and the predicted humidity is equal to or higher than the second predetermined humidity K2 and below the first predetermined humidity K1, and half opens the grill shutter 12 in this area. This structure as well enables coordination between suppression of drop in the heating capability relative to a case in which the grill shutter 12 is fully opened and suppression of heat damage to the component in the power source compartment 102 relative to a case in which the grill shutter 12 is fully opened, when the griller shutter 12 is half opened.

In this example, the middle frosting likelihood level may be further divided into a plurality of levels, so that an extent of opening of the grill shutter is selected from those corresponding to the respective divided levels.

### Fourth Embodiment

FIG. 10 is a flowchart of an exemplary flowchart of a control method for suppressing frost formation to be executed by a frost suppression device according to a fourth embodiment. Different from the structure illustrated in FIG. 1 to FIG. 4, the control unit 20 of the structure in this example has a timer circuit, not illustrated. The shutter control unit 21 makes a prediction about frost formation at time t1 (FIG. 4), when the vehicle is first parked. In the case where frost formation on the outdoor heat exchanger 104 while the vehicle is parking is predicted, the grill shutter 12 is shut at a time immediately before the predicted frosting time t, for example, a time prior by a few minutes (for example, at time t5 in FIG. 4).

The processes in step S21 to S24 and S27 in FIG. 10 are the same as those in steps S1 to S4 and S7 in FIG. 3, respectively. With determination of YES in step S24, the shutter control unit 21 does not shut the grill shutter 12 at time t1, at which the vehicle is first parked, but turns on the timer circuit, and stops operation of the operation processing unit of the control unit 20 other than the timer circuit. When it becomes a time immediately prior to the predicted frosting time, for example, a time prior by a few minutes, as measured by the timer circuit, in S26 the operation processing unit of the control unit 20 other than the timer circuit is activated and the grill shutter 12 is fully shut under control by a motor. Ending the process in step S26 ends the control processing for frost suppression.

As the structure in this example can reduce the frequency of unnecessary shutting of the grill shutter 12 while the vehicle is parked, heat damage to the components in the power source compartment while the vehicle is parked can be suppressed. Further, as only the timer circuit of the control unit 20 is operating while the vehicle is parking until a time immediately before the predicted frosting time, reduction in charge amount of a battery can be made less. In this example, the structures and operations other than those mentioned above are the same as those of the structure in FIG. 1 to FIG. 4.

In the case where the grill shutter 12 is shut immediately before the predicted frosting time while the vehicle is parked, the engine may be activated to drive a generator to charge the battery, provided that an engine activation condition, is satisfied, such as that the cooling water for the engine is at a predetermined temperature or below. This can reduce the extent of reduction in charge amount of the battery. Alternatively, the grill shutter 12 may be shut immediately before the predicted frosting time while the vehicle is first parked only when the battery is being charged with an outside power source while the vehicle is parked. This can reduce the extent of reduction in charge amount of the battery without activating the engine while the vehicle is parked, and also can suppress heat damage to the components in the power source compartment while the vehicle is parked.

What is claimed is:

1. A frost suppression device for a vehicle, comprising:
a grill shutter disposed in front of an outdoor heat exchanger for heating a cabin of the vehicle;
a shutter control unit for controlling opening and shutting of the grill shutter; and
a weather information obtaining unit for obtaining weather information containing change over time in predicted outside air temperature at a current position of the vehicle,
wherein
the shutter control unit makes a prediction about frost formation to predict whether frost may be formed on the outdoor heat exchanger, based on the predicted outside air temperature, when the vehicle is first parked,
the prediction about frost formation predicts that frost formation on the outdoor heat exchanger may begin at a time when the predicted outside air temperature becomes equal to or below a predetermined temperature, and
the shutter control unit shuts the grill shutter before a predicted frosting time when the frost formation on the outdoor heat exchanger is predicted to begin.

2. The frost suppression device for a vehicle according to claim 1, wherein
the weather information contains change over time in at least one or more of predicted humidity, predicted snow accumulation, and a predicted speed of wind from a front side of the vehicle at the current position of the vehicle, and
the prediction about frost formation predicts whether frost may be formed on the outdoor heat exchanger, based on the predicted outside air temperature and any one or more of the predicted humidity, the predicted snow accumulation, and the predicted speed of wind from the front side of the vehicle, when the vehicle is first parked.

3. The frost suppression device for a vehicle according to claim 1, further comprising an indoor/outdoor determination unit for determining whether a vehicle equipped with the frost suppression device is located indoors or outdoors,
wherein
the shutter control unit does not make the prediction about frost formation and does not shut the grill shutter when the indoor/outdoor determination unit determines that the vehicle is located indoors.

4. The frost suppression device for a vehicle according to claim 1, wherein the shutter control unit determines a level of likelihood of frost formation when making the prediction about frost formation, based on a difference and a large/small relationship between the predicted outside air temperature, contained in the weather information, and the predetermined temperature, and selects an extent of opening of the grill shutter in accordance with the level determined.

5. The frost suppression device for a vehicle according to claim 2, further comprising an indoor/outdoor determination unit for determining whether a vehicle equipped with the frost suppression device is located indoors or outdoors,
wherein
the shutter control unit does not make the prediction about frost formation and does not shut the grill shutter when the indoor/outdoor determination unit determines that the vehicle is located indoors.

6. The frost suppression device for a vehicle according to claim 2, wherein the shutter control unit determines a level of likelihood of frost formation when making the prediction about frost formation, based on a difference and a large/small relationship between the predicted outside air temperature, contained in the weather information, and the predetermined temperature, and selects an extent of opening of the grill shutter in accordance with the level determined.
